(19) United States
(12) Patent Application Publication
(10) Pub. No.: US 2013/0047825 A1
(43) Pub. Date: Feb. 28, 2013

(54) Method of Improving the Acoustic Response of Musical Instruments

(71) Applicant: Gregory Lawrence Kernaghan, Springbrook (AU)

(72) Inventor: Gregory Lawrence Kernaghan, Springbrook (AU)

(21) Appl. No.: 13/217,425

(22) Filed: Aug. 25, 2011

(51) Int. Cl. G10H 3/00

(52) U.S. Cl. 84/723

(57) ABSTRACT

A method for treating musical instruments is provided. The method applies suitable acoustic energy through the surrounding medium (e.g., air) without direct contact between the instrument and the acoustic source so as to achieve a more desirable response and performance form the musical instrument. In some embodiments, the instrument is properly supported and positioned with respect to an audio source, which audio source is driven with a suitable tone or sequence or electrical driving signal, which audio source then provides the needed sound for the needed duration and cycle to achieve the transformation in the instrument.

### TECHNICAL FIELD

The present disclosure relates the methods for making and treating musical instruments so as to favorably affect their performance and sound.

### BACKGROUND

Musical instruments are designed to deliver pleasing or entertaining or otherwise desired sounds. The build materials, manufacture, configuration, environmental conditions and other factors contribute to the unique sound of an instrument, with certain instruments made by certain builders being prized for their excellent acoustic performance and response.

Notwithstanding the electronic elements of some modern instruments, many traditional instruments include materials in their manufacture that are affected by the environment and conditions of use of the instruments. Older “seasoned” instruments are often attributed improvements in sonic characteristics wrought by the effects of age in concert with regular use. As such an instrument (for example a violin) is played, it is subject to the effects of vibration. Over an extended period of time, such vibratory forces can impart both subtle and overt changes in the acoustic response of the instrument.

Some in the field have examined the performance of acoustic systems by using modal analysis to study the response of acoustic systems, which in some cases might be useful to applying the present methods, see, e.g., “Experimental Modal Analysis” by B. Schwartz and M. Richardson, CSI Reliability Week (1999). Further discussion of modal analysis methods is described in “Modal Analysis Identification Techniques” by N. Maia and J. Silva, Phil. Trans. R. Soc. Lond. 359 (2001). Modal analysis of musical instruments can derive information relating to the natural and driven characteristics thereof, including in the presence of nodal conditions. In addition, efforts to expedite the subtle structural and concomitant sonic changes associated with the maturation of an instrument have been addressed previously in a number of Patents (e.g., Ashworth U.S. Pat. No. 5,031,501 and Rabe and Tobias U.S. Pat. No. 5,537,908). Both of these approaches require a direct physical connection between the instrument and the source of auditory or vibrational energy. Ashworth requires the direct attachment of a transducer to the instrument. Rabe and Tobias require that the subject instrument is physically secured to an electrodynamic vibrating surface.

The direct physical connection between the instrument and the source of auditory or vibrational energy required by the abovementioned prior art engenders acoustic damping of the instrument body, thus limiting the instrument's natural harmonic responses to stimulation. In addition, the direct physical interaction between the instrument and the source of stimulus increases the potential for physical damage to the instrument or other mechanical mal effects of such contact.

Further, in the case of Ashworth, stimulation material is applied with regard to replicating a normal musical program only. Rabe and Tobias describe the application of a “broadband spectrum” delineating only between two general classes of instruments and their associated broad frequency bands: (a) 20 Hz to 2 kHz for: instruments having a relatively low frequency spectrum (drums, bass guitars and bass violins) and (b) 20 Hz to 4 kHz “for other instruments (guitars, violins etc.)”.

Each of the processes associated with the above-mentioned prior art involve methods of stimulation which either directly necessitate damping by way of a fixing or involve damping of the instrument body during treatment phase by way of the application of a transducer to the instrument body, thereby restricting the instrument's subtle and complex harmonic response to stimulus. Neither of the above references employs a natural or contact-free process to the instruments.

### SUMMARY

The present invention relates to a process that can be applied to musical instruments (or components thereof) during or after the manufacturing process to expeditiously obtain improvements and changes in acoustic response and characteristics of resonance typically associated with “matured”, “seasoned” or “played-in” instruments. Among other features and advantages, the present invention provides a method of treating a musical instrument or component thereof including supporting the music instrument or component thereof using non-dampening supports; arranging a speaker proximal to and directed towards the instrument or component thereof; providing an audio frequency generator in communication with an amplifier and the speaker; determining at least one frequency of natural resonance of the instrument or component thereof or at least one latent frequency of the instrument or component thereof; and generating the at least one determined frequency with the audio frequency generator and subjecting the instrument or component thereof to the determined frequency via the speaker.

In a preferred embodiment, the step of determining at least one frequency of natural resonance of the instrument or component thereof includes the steps of providing a non-contact vibration sensor directed at the instrument or component thereof; performing a diagnostic audio sweep of the instrument or component thereof by sweeping and audio spectrum with one or more waveforms derived from the output of the audio frequency generator and directed at the instrument or component thereof via the speaker; and using data from the non-contact vibration sensor and the audio frequency generator to determine at least one frequency of natural resonance of the instrument or component thereof.

In an embodiment the vibration sensor is a laser Doppler vibrometer. In another embodiment, the audio spectrum used in the diagnostic audio sweet is from 20 Hz to 20 kHz. In yet other embodiments, the step of determining at least one frequency of natural resonance of the instrument or component thereof includes the steps of lightly touching the instrument or component thereof; performing a diagnostic audio sweep of the instrument or component thereof by sweeping an audio spectrum with one or more waveforms derived from the output of the audio frequency generator and directed at the instrument or component thereof via the speaker; and using biological feedback from the light touch on the instrument and data from the audio frequency generator to determine at least one frequency of natural resonance of the instrument or component thereof.

In some embodiments, the audio spectrum used in the diagnostic audio sweep is from 20 Hz to 20 kHz. In other embodiments, the at least one frequency of natural resonance of the instrument or component thereof is determined by extrapolating known data in relation to the instrument or component thereof.

The at least one frequency of natural resonance preferably comprises the fundamental and higher order nodes of resonance of the instrument or component thereof.

According to an embodiment, the audio frequency generator generates a swept sine signal. According to another embodiment, the non-dampening supports comprise at least one suspension line suspending the instrument or component thereof. Further preferably, the suspension line is a thin nylon line or rubber shock cord.

In some embodiments, the method preferably further comprises the step of conducting a modal analysis of the instrument or component thereof after subjecting the instrument or component thereof to the determined frequency in order to determine changes to the characteristics of the instrument or component thereof.

Additionally, the instrument or component thereof may be subjected to the determined frequency at amplitude that exceeds amplitudes experienced during normal playing conditions for the instrument.

In an embodiment, the instrument or component thereof is subjected to the determined frequency for a period of time sufficient to cause a change in the acoustic characteristics of the instrument or component thereof. More preferably, the instrument or component thereof is subjected to the determined frequency for a period of between 6 to 12 hours, but other durations can be determined by the individual response of the instrument and by suitable application of an appropriate driving signal and intensity.

### BRIEF DESCRIPTION OF THE DRAWINGS

A preferred embodiment of the invention will now be described by way of specific example with reference to the accompanying drawings, in which:

FIG. 1 illustrates an exemplary a schematic representation of a system in which an instrument being treated;

FIG. 2 illustrates an exemplary method for treating a musical instrument; and

FIG. 3 illustrates two exemplary stages of diagnosing and treating an instrument according to the present method.

### DETAILED DESCRIPTION

As discussed briefly above, musical instruments are prized mostly for the fidelity and quality of their sound production performance. Those skilled in the creative arts of music can determine the difference between an instrument having a fine performance quality, and therefore, such instruments can fetch greater sale prices and give greater satisfaction to their users and audiences.

To date, the quality of an instrument has been limited by the materials and methods of manufacturing, where high quality manufacture entails potentially very high pricing. Some instruments are known to ripen, mellow, mature, or improve in tone and quality through use, but this use requires a long time to reach the point where such improvements are obtained. It is useful to have a method for enhancing and improving such instruments, preferably prior to first sale by the manufacturer, without needing a player to play the instruments for months or years on end to achieve the improvement. Alternatively, it is useful to have such a method so that a post-sale dealer or user can him or herself develop the improvements in a relatively short time so as to soon after purchase enjoy the better performance of the instrument.

This can generally be done according to preferred embodiments of the present invention by exposing the instrument to an appropriate amount and type of acoustic signal. More specifically, by subjecting the instrument to an audio signal of selected type, strength and duration, the audio signal is made to favorably affect the instrument as will be described in more detail below. Still more specifically, the present method can be applied without interfering with (or by minimally interfering with) the instrument's natural vibratory modes of oscillation. In the preferred embodiments, this is done by subjecting the instrument to such acoustic waves for some duration, said acoustic waves transmitted through the air from an amplified audio source without direct physical or mechanical contact between the instrument and the audio source and furthermore without adversely restraining the instrument through mechanical coupling to the audio source.

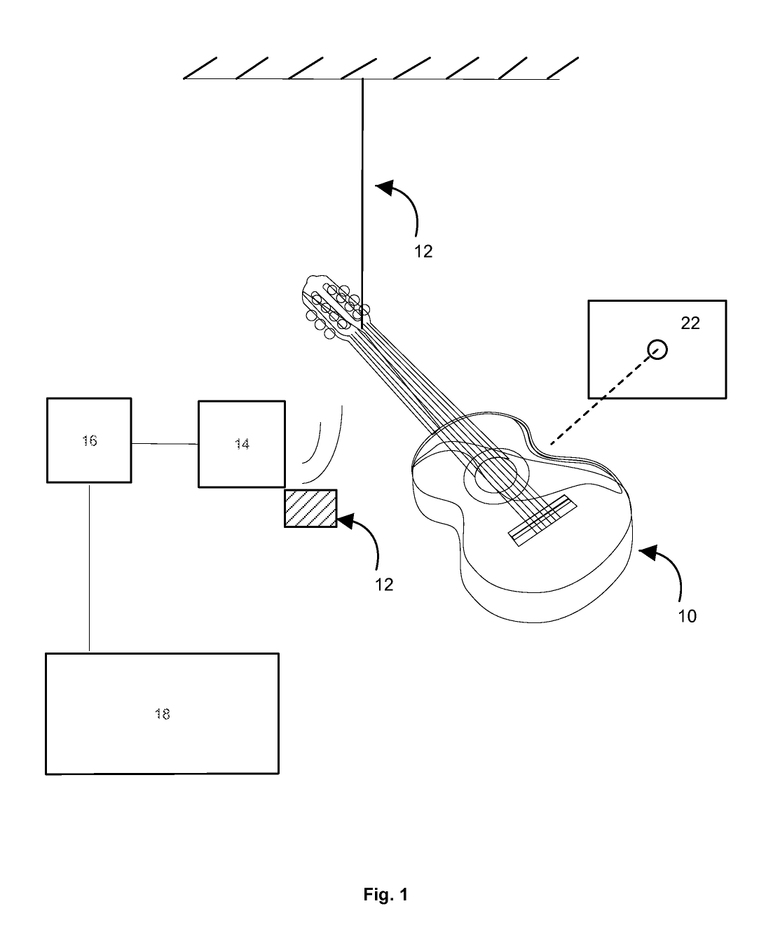

By way of illustration, FIG. 1 shows a musical instrument 10 (e.g., acoustic guitar or violin) that is first diagnosed to determine the frequencies of a natural resonance of the instrument 10 and then treated to improve the acoustic response of the instrument 10 using the determined frequencies of natural resonance.

The instrument 10 is suspended above the ground from its headstock or instrument strap anchors using a suspension line 12, such as a thin nylon line or rubber shock-cord, such that the instrument 10 is relatively free to resonate without significant dampening. The instrument's 10 orientation may be fixed by the application of additional tethers subject to their ability to allow the instrument 10 to resonate freely.

A loudspeaker system comprising one or more loudspeakers 14 and an audio amplifier 16 capable of producing a broad range of frequencies at high amplitude (i.e. 20 Hz-20 kHz+/−3 db @ >103 db SPL) is placed in close proximity to and facing the instrument 10 under test.

An audit frequency generator 18 capable of outputting various waveforms (i.e. sine, square, ramp, pulsed) across the audible spectrum (i.e. from 20 Hz to 20 kHz) is connected to the one or more loudspeakers 14 via the audio amplifier 16.

A sound pressure meter 20 capable of accurately measuring the sound pressure level (SPL) of the loudspeaker 14 across the audible spectrum is placed in front of the loudspeaker 14.

A suitable laser Doppler vibrometer 22 capable of measuring the vibrational intensity and frequency of the instrument 10 or component thereof between 20 Hz and 20 kHz is placed in a position suitable for the recording and/or monitoring of the vibrational response and profile of the instrument 10 or component thereof under analysis.

The instrument 10 under analysis subjected to a sweep of stimulation signal (i.e. sine, square, ramp, pulsed wave forms) at frequencies ranging from 20 Hz to 20 kHz. These sweeps are conducted at fixed amplitude sufficient to demonstrably excite the musical instrument 10 at frequencies of natural resonance for the musical instrument 10 under analysis. The SPL meter 20 can be used to verify that the nature of the sweep is of a relatively fixed amplitude should conditions of repetition be required.

Data from the vibration sensor 22 is cross-referenced with the output frequency and waveform data from the audio frequency generator 18, measurements from the SPL meter 20 and frequency data from the vibrometer 22. Conditions associated with the expression of self resonant nodes and higher order nodes are determined and recorded for later us. These conditions are expressed as relative peaks in vibrational amplitude on the part of the instrument 10 or component thereof under study.

Alternatively, data relating to the frequencies of natural resonance of a particular instrument 10 may be known or extrapolated from existing data on the instrument 10 of an identically manufactured instrument.

Based on the conditions of peak resonance obtained above, the musical instrument 10 is subjected to a program of exposure to specific frequencies and waveforms, being excitation signals comprised of frequencies identified as being those associated with the fundamental and higher order nodes of resonance of the instrument 10 at an amplitude within the structural limitations of the instrument 10, but typically at or above the maximum level anticipated in normal use until a satisfactory change in acoustic and harmonic qualities of the instrument 10 are obtained. The instrument 10 is subjected to this treatment for a sufficient duration to effect a change in the harmonic and acoustic response of the instrument 10 at a greater rate than that which would otherwise be obtained during the course of the instrument's 10 normal “maturation” or “opening up” process.

This treatment results in relatively expeditious changes to the instrument's acoustic properties the nature of which are akin to the time intensive changes typically associated with “matured”, “played-in” or “seasoned” instruments.

The treatment is preferably performed on specific classes of musical instruments which can benefit from the treatment including those instruments whose sonic character is determined at least in part by the physical resonances of the instrument's body or parts thereof and whose acoustic properties are known to be subject to change in accordance with the passage of time and use. Such instruments include violins, cellos, double basses, acoustic guitars, solid body electric guitars, mandolins, acoustic pianos, electric and acoustic bass guitars, clarinets, oboes, acoustic drums, wooden bodied harps etc.

The introduction of laser Doppler vibrometry within the field of modal analysis has meant that vibration amplitude and frequency data can be obtained using non-contact methods. For analysis of musical instruments, this means that harmonic analysis can be undertaken free from the effects of damping associated with the use of contact vibrometers or accelerometers. In addition, the availability of scanning laser Doppler vibrometers (SLDV) means that simultaneous capture of complex resonance data for the entire surface of an instrument is now possible. Hence, it is technically possible to obtain a high level of understanding about a musical instrument's inherent resonances and the complex harmonic interplay of those resonances expressed in terms of the frequencies and relative amplitudes of fundamental and higher order nodes.

Instrument harmonic excitation levels can be measured in a number of ways. In lieu of an SLDV sensor aimed at the instrument and capable of determining vibration frequency and amplitude across the audio frequency spectrum at the multiple points of reference, single point laser Doppler vibrometry can deliver broadly equivalent data albeit at the expense of time associated with setup at multiple points of observation across the instrument.

Basic relative vibrational intensity can also be ascertained using bio-feedback by the application of the human hand very lightly upon the body of the instrument during a diagnostic sweep. A peak in the relative intensity of the instrument's reaction to the sweep is usually easily detected and can be cross-referenced with the audio frequency generator to determine the specific frequency, waveform and bandwidth associated with that harmonic response.

An appropriate non-contact vibration sensor in collaboration with a suitable sound pressure level meter, ensuring the excitation signals are generated in accordance with a meaningful reference level, is however and excellent basis upon which the harmonic response of the instrument can plotted and later referenced when assessing changes brought about by the treatment regime.

Scanning laser Doppler vibrometers allow the simultaneous capture of vibratory data from a multitude of reference points on the instrument or part thereof and are therefore the most efficient means of acquiring detailed information about an instrument's harmonic resonance profile. Single point laser Doppler vibrometers can obtain a functional level of detail if relocated to a sufficient number of reference points of potential harmonic interest between sequential standardized diagnostic sweeps.

In practice, contingent upon the particular design of the instrument under analysis, an instrument's fundamental and higher order inherent resonances can be determined from a relatively small number of reference points generally negating the need for an expensive scanning laser Doppler vibrometer. However, the highly detailed analysis of an instrument's harmonic profile afforded by the use of a SLDV provides an excellent basis for comparison between pre- and post-treatment analysis, profiling and management of the instrument's complex harmonic character in addition to coherent identification of harmonic troughs of interest.

The data derived from such a modal analysis is used to identify frequencies for stimulation of the instrument 10 which when delivered at sufficient amplitude and duration both accelerates the maturation process and assists in tonal shaping of the instrument 10.

The stimulation frequencies are primarily selected on the basis that they have been identified during modal analysis as either fundamental nodes of resonance, higher order nodes of resonance or frequencies which are “latent frequencies” and in need of propagation in order to improve the sonic quality or tonal shaping of the instrument 10. Therefore, some stimulation frequencies may be selected in accordance with their specific contribution to the overall tonal shaping of the instrument in lieu of the instrument body's natural nodes of resonance. An example includes fourth order harmonics from the equal tempered major and minor diatonic scales whose greater prominence is often associated with violins of higher quality. The term “latent frequency” is used throughout the specification to define any such frequency from the major and minor diatonic scales at which an instrument resonates at less than optimum amplitude. While stimulation of latent frequencies can improve the sonic quality and tonal shaping of an instrument, it should be noted that the greatest and most expeditious audible improvements in acoustic response are obtained in association with the results of high amplitude stimulation at the instrument body's fundamental and higher order nodes of resonances.

Once identified, the instrument 10 is subjected to that frequency or group of frequencies at relatively high amplitudes which typically exceed those present during normal use but are below that which could cause structural damage or failure to the instrument 10 and for a period of time sufficient to expeditiously effect a positive change in the acoustic response of the instrument 10. A typical time period often sufficient to effect a noticeable change is between 6 and 12 hours but may be more or less depending on specific circumstances.

Subtle and overt changes in the acoustic response of the instrument 10 can be quantified by a subsequent modal analysis based on the same analytic procedure as that employed before the high-amplitude stimulation treatment.

Several classes of stimulation signals are available for the purposes of modal analysis and treatment. These include transient, periodic in the time window, random and harmonic. For the purposes of the present method, a swept sine excitation signal is generally the most appropriate because slowly swept sine can be used for single point measurements, and sweep excitation can allow for the detection of resonance of very lightly damped structures which may otherwise remain undetected by alternative excitation signals.

Using the combination of an audio frequency generator capable of producing various waveforms from 20 Hz to 20 kHz and a loudspeaker system capable of reproducing a wide range of frequencies at an amplitude sufficient to excite the body of the instrument at its natural and harmonically related points of resonance, the modal analysis and treatment phases can be completed in an entirely non-contact environment.

Peaks and troughs in the excitation or vibrational characteristics of the body of the instrument indicate the particular frequencies at which the instrument, its body or parts thereof are inherently more or less resonant. Specific treatment phase frequencies are subsequently chosen based upon peaks in the sympathetic response of the instruments as recorded and determined during the diagnostic sweep phase or alternative frequencies demonstrated as lacking and in need of propagation. For example, higher relative strengths of fourth order harmonics are often associated with higher quality violins. These frequencies can be targeted for propagation in addition to fundamentals where desired.

In the case of stringed instruments, the diagnostic sweep may be conducted in a number of ways and upon a number of music instrument conditions, including (i) upon an unstrung instrument (ii) upon a strung instrument and (iii) upon a strung instrument, the strings of which have been dampened to avoid anomalous (non-instrument-body) resonances.

The method employed to fix the instrument in close proximity to the audio frequency generator shall be such that said fixing wherever possible shall involve the suspension of the instrument in space by a means that does not prevent the instrument from responding freely to the audio stimulus. Unnecessary vibrational and harmonic damping should be avoided wherever possible.

An example of such a technique that may satisfy the requirement for minimal damping includes hanging a guitar from the headstock using a thin nylon line or rubber shock cord of minimum diameter sufficient to safely suspend the instrument above ground, in front of and in close proximity to the loudspeaker attached to the audio frequency generator equipment without risk mechanical failure throughout the diagnostic and treatment phase.

Typically, the front of the instrument or soundboard should face the source of the audio frequency excitation signal; however, experimental data suggests that the ideal orientation of the instrument for excitation will vary depending upon design. In many cases, it is appropriate to sweep and treat the instrument from a variety of angles in an attempt to better convey and improve reception of audio energy or excitation stimulus.

Methods of fixing the instrument, which dampen inherent harmonic responses, should be avoided. In addition, different components of some instruments exhibit different resonance profiles and may be targeted for treatment independently. The amplitude and duration of the treatment should be such that the physical integrity of the instrument shall not be compromised due to the effects of vibration.

Although the invention has been described with reference to specific examples, it will be appreciated by those skilled in the art that the invention may be embodied in many other forms.

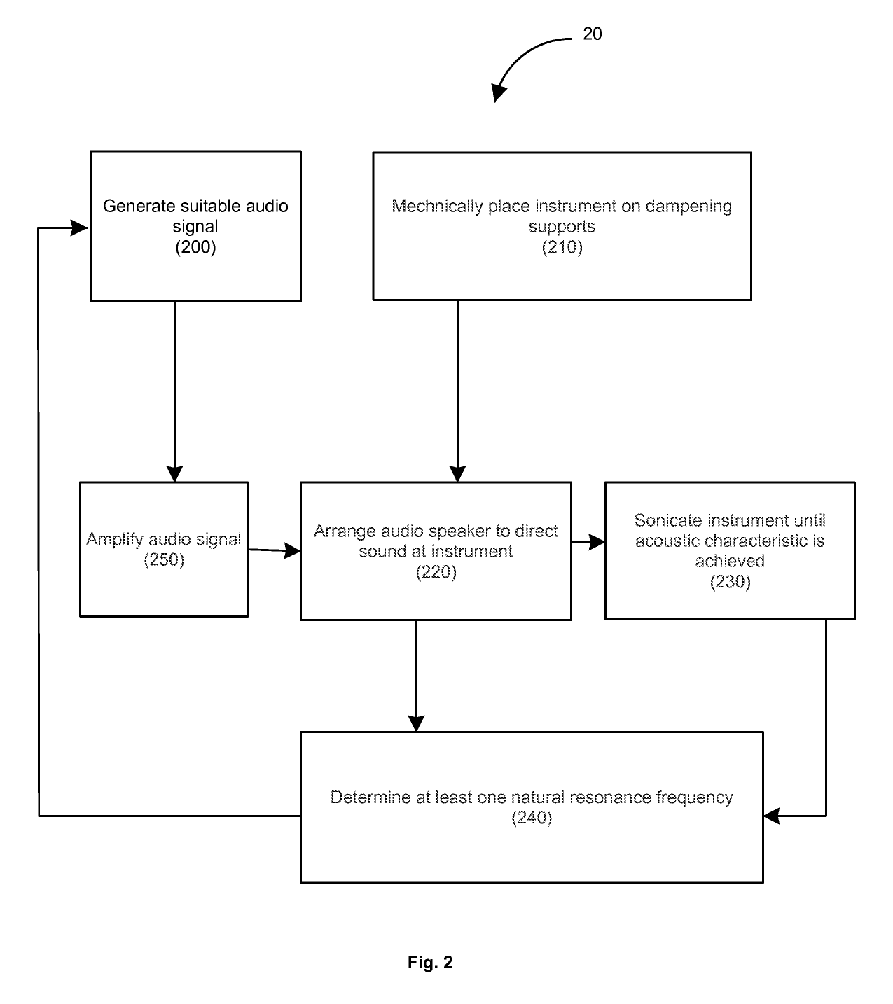

FIG. 2 illustrates an exemplary method for treating a musical instrument as described herein. A musical instrument is placed on dampening mechanical supports at step 210. An audio speaker is arranged and directed to deliver sound waves to the instrument at step 220. The step of delivering acoustic waves from the speaker to the musical instrument may be implemented through appropriate directional and distance settings between the audio speaker and the musical instrument.

At step 200 a suitable audio signal is generated; for example, from a signal generator and as described in more detail herein, the suitable audio signal may include one or more frequencies or tones or other electrical signals used to drive the audio speaker. At step 250, the suitable audio signal is amplified using an audio amplifier so as to provide an appropriate electrical signal and suitable amplitude there of for driving the audio speaker at the correct intensity. At step 230, the musical instrument is sonicated until the desired acoustic characteristic of the musical instrument is achieved. This may involve allowing the audio speaker to sonicate the musical instrument at the appropriate intensity and for a duration sufficient to achieve such modification in the acoustic characteristic of the musical instrument.

Periodically, or at some interval, a determination is made of at least one natural frequency that is appropriate for generating the suitable audio signal of step 200. Therefore, at step 240, a measurement may be made to determine said at least one natural resonance frequency.

The above process 20 may be repeated as necessary more than once or may be carried out only once for the appropriate duration of time.

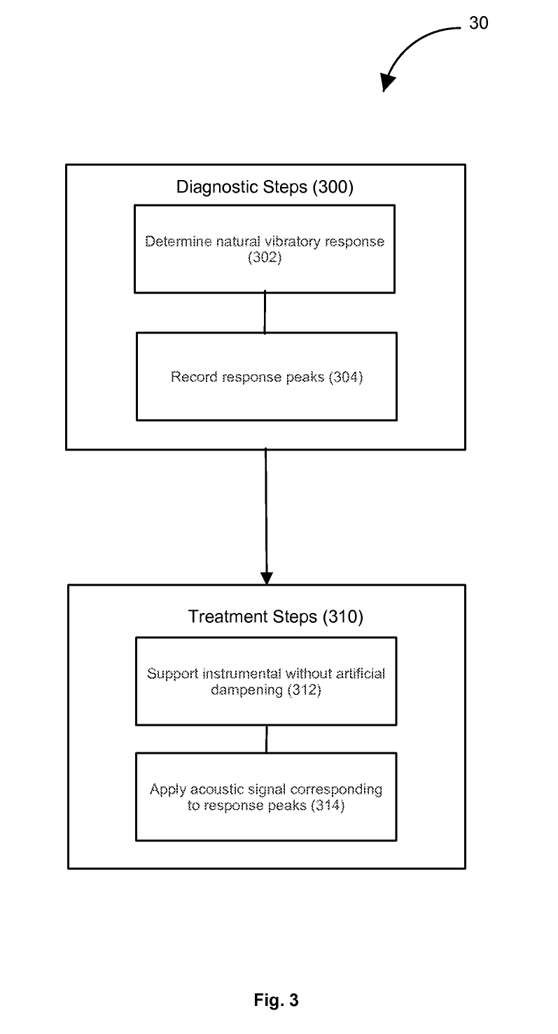

FIG. 3 illustrates an exemplary method comprising two main phases for treating a musical instrument according to a preferred embodiment. In the method 30, two phases comprise a diagnostic set of steps 300 followed by treatment steps 310.

Diagnostic steps 300 include a step of determining a natural vibratory response of the musical instrument 302. Also, a step of recording response peaks 304 that are determined as a result of the musical instrument's natural resonances and other construction features. The natural vibratory response peaks may indicate one or more natural frequencies of the musical instrument, which may then be used in the treatment steps 310 below.

Treatment steps 310 include supporting the musical instrument 312, preferably supporting the instrument without artificial dampening so that they instrument may respond to acoustic driving signals that are externally applied to the instrument. Treatment steps 310 then include applying an acoustical signal corresponding to the response peaks measured above. The step of applying the acoustic signal 314 is preferably accomplished by positioning an acoustical source proximal to and directed at the musical instrument without making physical mechanical contact with the instrument. As mentioned above, other techniques for driving an acoustic instrument have employed mechanically fixing a driver to the musical instrument, which can cause dampening of the musical instrument and inhibit natural response thereof. Here, the acoustic driving is applied to the musical instrument without touching the acoustical driver to the instrument. For example, air is used to propagate the acoustical sound waves from the source of the acoustical signal to the musical instrument, thereby causing the musical instrument to resonate and respond to the driving acoustical signal. By so doing for a predetermined or optimal amount of time and in a pattern and according to a suitable acoustic signal, the musical instrument may be transformed to improve its natural response, sound and other acoustical qualities of the instrument.

In yet other examples, the present techniques can be applied to improve the performance of musical instruments in a production line facility by treating more than one instrument substantially at the same time. Specifically, an instrument of a certain type can be tested to determine its response characteristics as described above. Then, a plurality of same, similar or same type of instruments may be treated using the same or similar treatment steps as would be applied to the actual instrument that underwent the testing. In other words, the production of fine musical instruments can be scaled up to treat a larger number of instruments by only subjecting one or a few instruments to testing, collecting the needed parameters, then subjecting the plurality of instruments of similar nature to the treatment steps above. This results in a greater manufacturing throughput of treated instruments.

The embodiments and description and drawings provided herein are illustrative and allow those skilled in the art to understand the inventions and to incorporate the inventions into systems and methods comprehended by the present disclosure and claims. The present embodiments should therefore not be considered exhaustive or limiting, but other derivative and similar techniques and devices relating hereto should be considered covered by the present scope of invention as well.

What is claimed is:

1. A method of treating a musical instrument to favorably affect its musical characteristics, comprising:
supporting said instrument with substantially non-dampening supports so as to substantially not affect any natural resonance characteristics of the instrument;
determining at least one natural response frequency of said instrument by:
exciting an acoustic output from the instrument,
sensing said acoustic output of said excited instrument,
processing an electrical signal corresponding to said acoustic output of the instrument so as to determine said at least one natural response frequency;
generating an electrical driving signal corresponding to at least said at least one natural response frequency;
amplifying said electrical driving signal to create an amplified electrical driving signal;
positioning an acoustic source with respect to said instrument so that there is substantially no physical contact between the instrument and the acoustic source;
driving the acoustic source with said amplified electrical driving signal to generate an audio treatment sound signal; and
delivering said audio treatment sound signal from said acoustic source to said instrument for a duration sufficient to affect a permanent change to said musical characteristics of the instrument.

2. The method of claim 1, further comprising placing an audio microphone or non-contact vibration sensor or laser Doppler vibrometer placed proximal to said instrument so as to sense the acoustic output of said excited instrument.

3. The method of claim 1, said processing act comprising modal analysis so as to determine said at least one natural response frequency.

4. The method of claim 1, said act of generating the electrical driving signal comprising generating a periodic signal having a center frequency corresponding to said natural response frequency.

5. The method of claim 4, said act of generating the electrical driving signal comprising generating a periodic signal having a center frequency at some multiple or fraction of said natural response frequency.

6. The method of claim 1, said act of positioning said acoustic source comprising placing an audio speaker proximal to said instrument.

7. The method of claim 1, further comprising placing the instrument and the acoustic source within a sound-resistant enclosure.

8. The method of claim 1, said act of determining said at least one natural response frequency comprising performing a diagnostic audio sweep of the instrument with a plurality of frequencies including a range of frequencies between 20 Hz and 20 kHz.

9. The method of claim 1, said acts of supporting, determining and delivering comprising supporting, determining and delivering as to a component of said instrument.

10. The method of claim 1, said at least one natural response frequency of said instrument comprises a latent frequency thereof.

11. The method of claim 1, said act of generating comprising generating a sweep of a plurality of frequencies including said natural response frequency.

12. The method of claim 1, said act of supporting the instrument comprising suspending the instrument from a non-rigid fiber such as a cord or a string.

13. The method of claim 1, said delivering act comprising delivering said audio treatment sound signal from said source to a plurality of similar instruments so as to treat said plurality of similar instruments substantially at the same time.

14. The method of claim 1, said positioning, driving and delivering acts comprising positioning a plurality of acoustic sources with respect to a plurality of musical instruments of a same type, driving the acoustic sources with a same or similar amplified electrical driving signals to generate corresponding plural audio treatment sound signals, and delivering said plural audio treatment sound signals to said plurality of musical instruments substantially at the same time.

15. The method of claim 1, said act of supporting the instrument comprising supporting the instrument at one or more locations on a housing of said instrument said one or more locations being substantially at corresponding nodes so that said supporting would substantially not interfere with the natural response of the instrument.

16. A system for treating a characteristic of said musical instrument, comprising:
a non-dampening support with which said instrument may be supported;
a diagnostic unit including an audio sensor that senses an acoustic output of said instrument and a processor for processing an output of said audio sensor corresponding to the audio output of the instrument and further for generating an electrical driving signal;
an amplifier for amplifying said electrical driving signal to make an amplified electrical driving signal;
an audio source positioned with respect to said instrument, and that receives said amplified electrical driving signal and delivers an audio treatment sound to said instrument; and
a treatment control unit that controls an output of said audio source so as to permanently affect said characteristic of said instrument.

17. The system of claim 16, said processor comprising a signal processor for extracting at least one natural response frequency from said output of said audio sensor.

18. The system of claim 16, said audio sensor comprising a non-contact vibrometer.

19. The system of claim 16, said audio sensor comprising a laser Doppler vibrometer.

20. The system of claim 16, said audio sensor comprising a microphone.
